(19) United States
(12) Patent Application Publication
(10) Pub. No.: US 2012/0104996 A1
(43) Pub. Date: May 3, 2012

(54) MOBILE REGULATION AND CHARGING UNIT

(75) Inventors: Jostein Eikeland, Boca Raton, FL (US); Stein Christiansen, Parkland, FL (US); Christopher Christiansen, Parkland, FL (US)

(73) Assignee: ALEVO, INC, Boca Raton, FL (US)

(21) Appl. No.: 13/284,023

(22) Filed: Oct. 28, 2011

Related U.S. Application Data
(60) Provisional application No. 61/408,516, filed on Oct. 29, 2010.

(51) Int. Cl. H01R 39/00; H02J 7/00

(52) U.S. Cl. 320/107; 307/145

(57) ABSTRACT

An apparatus includes a connection unit configured to connect to a power line, a control arm coupled to the connection unit and capable of raising the connection unit for connection to the power line, a housing unit capable of storing one or more battery modules; and a control center configured to communicate with one or more entities, wherein the control center is further configured to initiate flow of electricity through the connection unit.

### CROSS REFERENCE TO RELATED APPLICATIONS

This application claims the benefit of U.S. Provisional Application No. 61/408,516, filed Oct. 29, 2010, which is incorporated herein by reference in its entirety for all purposes.

### BACKGROUND

Today's power transmission infrastructure is inefficient. The amount of energy lost on a daily basis due to transmission losses in the power grid results in considerable inefficiency. Minimizing such inefficiency can substantially reduce energy cost, reduce carbon emission, and among other benefits, reduce our dependence on foreign oil imports.

There has been a trend in promoting the use of electric vehicles. However, the existing power transmission infrastructure cannot support the demand of electric vehicles on a large scale. Therefore, the deficiencies of the existing infrastructure will impede a wide spread adoption of electric vehicles that can have significant positive impact on the environment as well as energy costs.

Electric vehicles require an infrastructure designed to quickly charge and increase the vehicles range while on the road. However, the increased energy demand will amplify the strain on today's overloaded and inefficient power grid. The capability for charging while on the road is very important to ensure the success of electric and plug in hybrid vehicles.

Smart-grids and charge-points are costly to deploy and require upgrades at the charge locations to accommodate the increase demand by the electric vehicles. The power grid also needs local storage locations and energy banks for responding to sudden increase or decrease in power usage by having the capability of regulating up and down respectively. Alternative natural energy sources such as wind and geothermal energy may be used to supplement the increased energy need that will be imposed by the electric vehicles. However, the lack of storage and sufficient transmission resources in peak periods is the main limitation of alternative natural energy sources.

Local storage capabilities within the grid with available capacity during peak periods are critical to balancing the power grid. Today, there are thousands of inefficient standby generators that are called upon to supply the power grid during peak periods. The ability to store large amounts of energy to resupply the grid during peak hours is a key aspect in order to maximize current resources, limit the use of insufficient and pollution intensive generators, and enhance the ability to plan and forecast energy production needs.

Today, even without the wide spread adoption of electric vehicles, the existing power grid cannot accommodate the existing energy demand at all times. Unanticipated energy demands results in a number of blackouts each year. The annual cost of blackouts is estimated at almost 100 billion dollars. Installing emergency generators for backup power can be costly and unattainable for many small and medium sized businesses as well as for residential properties. Without local storage in the power grid, the cost of blackouts will continue to rise as our dependence on electricity continues to grow.

Therefore, there is a need for having the capability of storing energy and effectively supplying and regulating the power grid. Embodiments of the invention will address these and other problems, individually and collectively.

### BRIEF SUMMARY

One embodiment of the invention is directed to a mobile grid regulation and charging station having a connection unit configured to connect to a power line, a control arm coupled to the connection unit and capable of raising the connection unit for connection to the power line, a housing unit capable of storing battery modules, and a control center configured to communicate with one or more entities, and to initiate flow of electricity through the connection unit.

Another embodiment of the invention is directed to one or more outlets coupled to the housing of the mobile grid regulation and charging station and for providing electricity from the battery modules.

Another embodiment of the invention is directed to directing electricity from the connection unit to the one or more battery modules and charge the battery modules via the electricity from the power line.

Another embodiment of the invention is directed to directed electricity from the battery modules to the power line.

Another embodiment of the invention is directed to placing a mobile regulation and charging station in proximity of a power line, connecting a connection unit to the power line by rising a control arm of the mobile regulation and charging station that is coupled to the connection unit; and directing the flow of electricity to and from the power line using a control center coupled to the mobile regulation and charging station.

Another embodiment of the invention is directed to communicating with a control center of a mobile regulation and charging station; sending a command to the control center to connect a connection unit to a power line by rising a control arm coupled to the connection unit; and sending a command to the control center to initiate flow of electricity to and from the power line.

The following detailed description and the accompanying drawings provide a better understanding of the nature and advantages of the present invention.

### BRIEF DESCRIPTION OF DRAWINGS

FIG. 1 is a drawing of a mobile grid regulation and charging station connected to the power grid, according to an embodiment of the invention.

FIG. 2 is a schematic illustration of a mobile grid regulation and charging station, according to an embodiment of the invention.

FIG. 3 illustrates the connection of the arms of the mobile grid regulation and charging station to the power station, according to an embodiment of the invention.

FIG. 4 illustrates some of the components of the mobile grid regulation and charging station, according to an embodiment of the invention.

FIG. 5 illustrates the connection of the mobile grid regulation and charging station to the power grid, according to an embodiment of the invention.

FIG. 6 illustrates some of the components of the mobile grid regulation and charging station, according to an embodiment of the invention.

FIG. 7 is a flowchart that illustrates the steps involved in operation of the mobile grid regulation and charging station, according to an embodiment of the invention.

### DETAILED DESCRIPTION

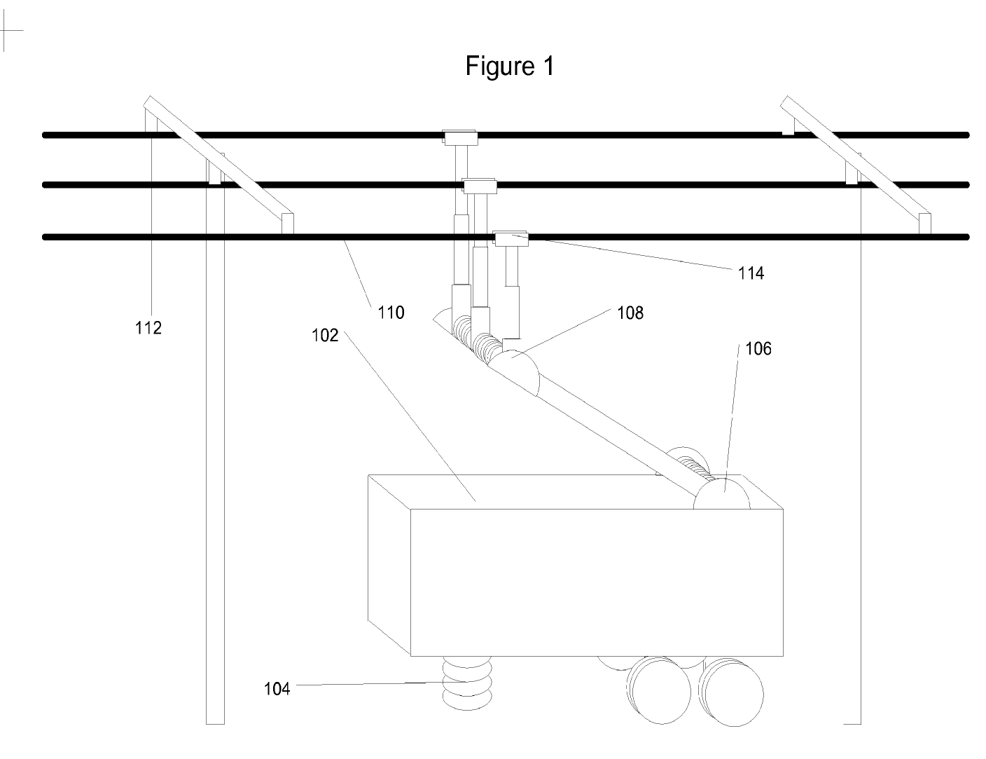

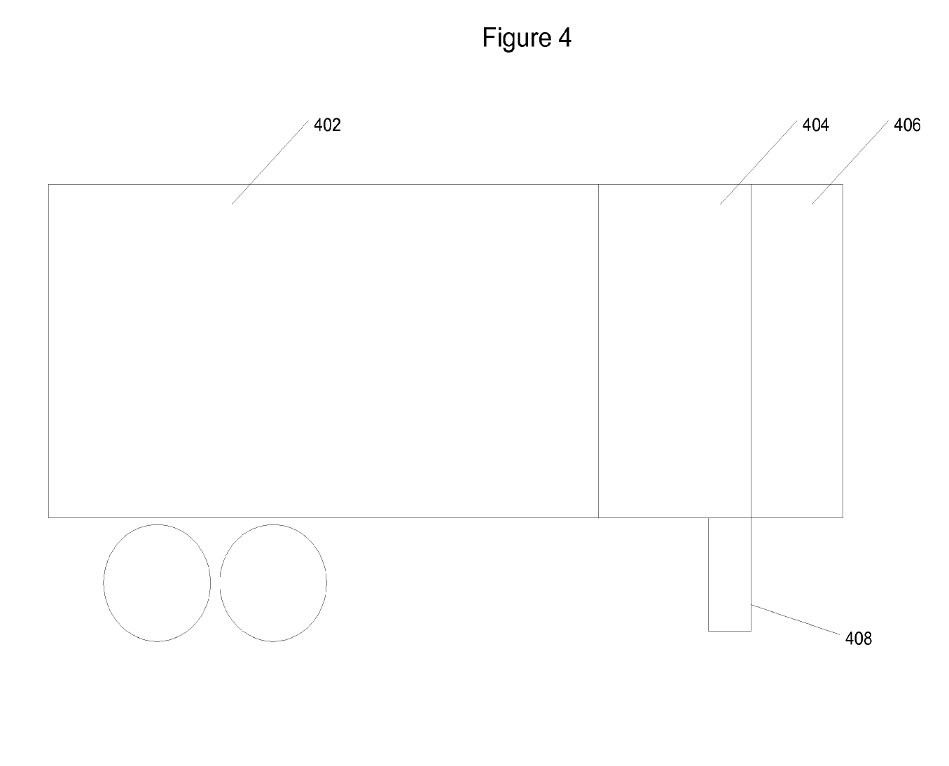

FIG. 1 illustrates the mobile grid regulation and charging station 102 when it is connected to the power grid 112. In some embodiments, the mobile grid regulation and charging station 102 is in a form of a trailer that can be moved to any desired location in the power grid. The mobile grid regulation and charging station 102 may be connected to the power lines through the telescopic grid connection 114. As shown in FIG. 1, the telescopic grid connection 114 is lifted by the control arm 106. In some embodiments, the mobile grid regulation and charging station 102 may utilize batteries as an energy storage device. The energy flow within the grid may go through low or medium voltage power line. Each telescopic connection unit 114 may connect independently to a power line and the energy flow may not commence until all lines are connected and grid voltage level is verified. In some embodiments, grid connection may be verified by pressure sensors and camera (not illustrated) connected to control center 406 (shown in FIG. 4) in the mobile grid regulation and charging station 102, and connection may therefore be verified remotely through the control center's 406 communication protocols.

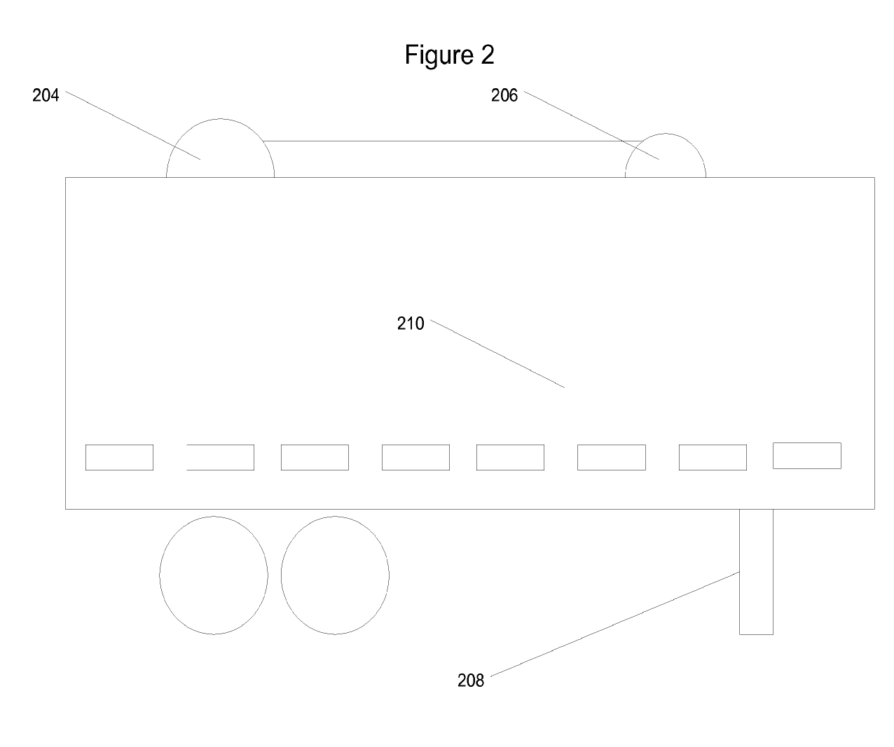

FIG. 2 illustrates some of the external components of the mobile grid regulation and charging station 210, according to an embodiment of the invention. The mobile grid regulation and charging station 210 may be any length depending on desired space for battery capacity. In some embodiments, the mobile grid regulation and charging station 210 may be in a form of a 54 foot trailer with standard height, and capable of an energy load ranging from 1 MW to more than 20 MW. In order to facilitate high energy transfers safely, the mobile grid regulation and charging station 210 may be equipped with a telescopic grid connection unit 204. The grid connection 204 may have a telescoping hydraulic or electric arm with 1 or more joints depending on desired height. The unit illustrated may be capable of attaching to low and medium voltage transmission lines at a height of more than 20 feet.

Each external connection 202 may be able to charge electric or electric plug in hybrid vehicles and other types of transport means including planes and boats. In some embodiments, external connection outlet 202 may be used to supply power for construction equipment. The mobile grid regulation and charging station 210 may charge up to 20 vehicles simultaneously through DC to DC connection. Each vehicle can be charged simultaneously as each outlet 202 may be connected to one or more battery modules and can therefore be discharged at desired level without the risk of overcharging battery packs that require lower energy density. Each outlet 202 may have a built in charger capable of adjusting the appropriate power desired for the connected electrically powered object.

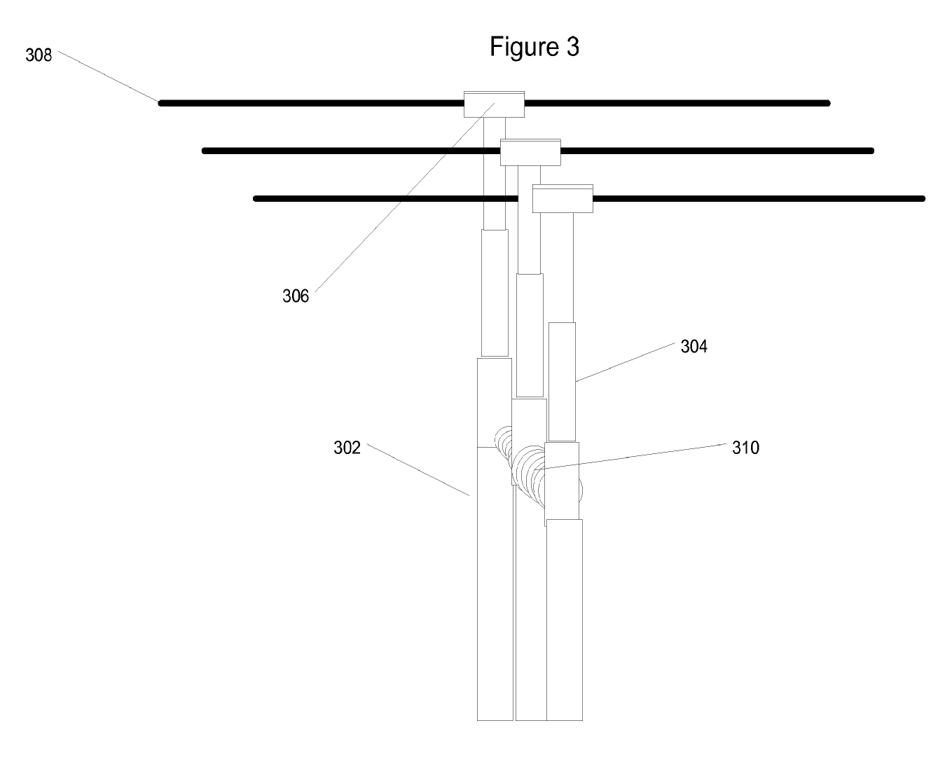

FIG. 3 illustrates the connection mechanism from the mobile grid regulation and charging station to the power line 308. The mobile grid regulation and charging station may have multiple connection points depending on needed application. Each connection 306 may connect independently and energy flow through each arm may not be initiated until all connection points are made, grid voltage verified and the onboard transformer 404 (FIG. 4) may be activated.

Connection arm 304 may be constructed as a three piece hydraulic or electric telescopic arm. Each piece 302 may have an aluminum or copper core capable of transferring high amounts of energy covered by a polymer insulation layer. The hydraulic or mechanical joint 310 may enable the arm to connect to power lines in a variety of heights and positions. Each arm may retract and fold through the hydraulic or mechanical joint 310 for safe and convenient transportation. Connection 306, which may be in a form of a clamp in some embodiments, may be hydraulic or electric and made of aluminum, copper or steel. The connection 306 may connection to low voltage and medium voltage power lines.

FIG. 4 illustrates the internal components of the mobile grid regulation and charging station 102. The energy bank 402 may be any type of organic or inorganic rechargeable batteries including lithium-ion, lead-acid, nickel metal hydride, sodium and lithium metal. The battery modules 404 may have a SO2 capture system as part of the battery packaging. The mobile station may have a main station control center 406. Control center 406 may receive and transfer information wirelessly or through PLC (power line communication). Control center 406 may communicate through standards such as SCADA (supervisory control and data acquisition), IEEE Synchrophaser C37.118, IEC60870, Zigbee and IEC 61850. Information collected in the control center 406 may include available energy in the mobile station, connected vehicles or attached removable energy sources, storage capacity and current energy utilization. In order for the station to quickly initiate regulation up or down, the station may be in constant two-way communication with governing utility company, Independent Service Operator (ISO) and any entity capable of utilizing the services provided by the mobile grid regulation and charging station 102.

In some embodiments, the mobile grid regulation and charging station 102 may have a capacity ranging from 1 MW to more than 20 MW. Battery packs 402 may transfer DC energy directly to the charge outlets 202 (FIG. 2). This enables the station to be utilized as a charging station for any fully or partially electrically powered equipment, machinery or vehicle. The outlets 202 may have a DC/DC converter. While a vehicle may be connected, the specific module charging the vehicle may not be available to transfer to the grid as the control center 406 may route power away from the specific module. In order for the station to connect to a variety of power lines, the onboard transformer 404 may be capable of accepting energy from low to medium voltage lines.

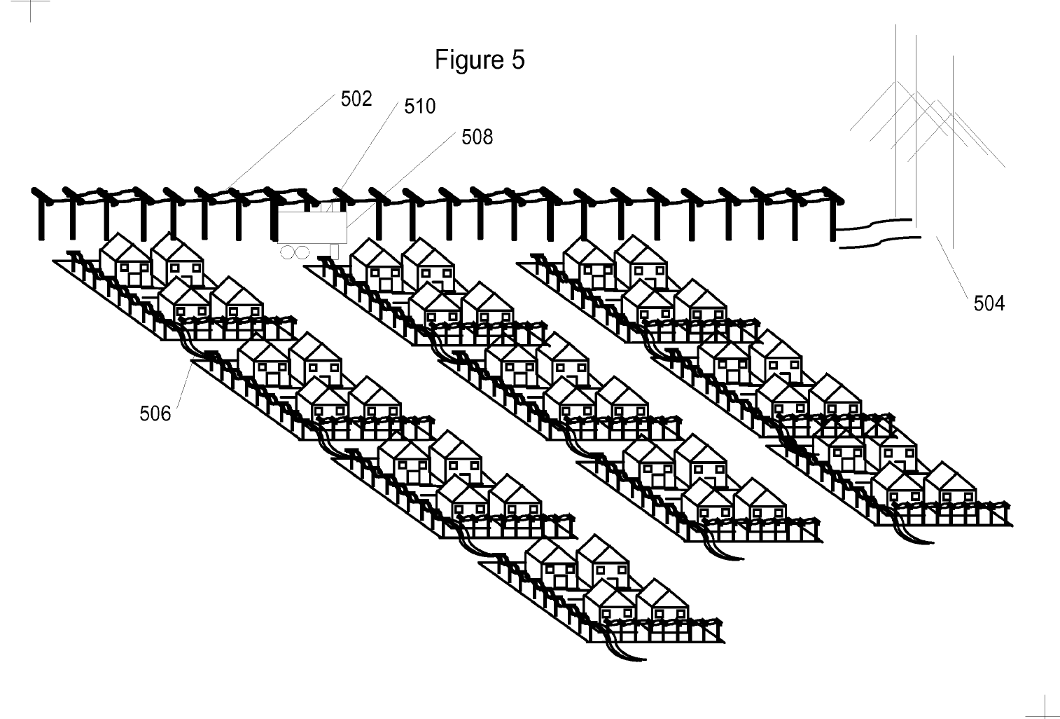

FIG. 5 illustrates the impact the mobile unit can have on utilization of renewable energy and energy routing. Due to the mobile regulation and charging station's 508 connection mechanism 510, the mobile regulation and charging station 508 may be able to provide localized regulation and thereby eliminate grid transmission losses due to transmission over long distances. Additionally, since the mobile regulation and charging station 508 is mobile, it may be charged close to renewable electricity generators and physically be relocated to local areas in need of power during peak power usage, or any area in need of emergency backup power. As the connection mechanism 510 may be completely automatic, the connection may be made in the manner of minutes which advantageously provides a fast movable spinning reserve capable of maximizing our utilization of renewable sources.

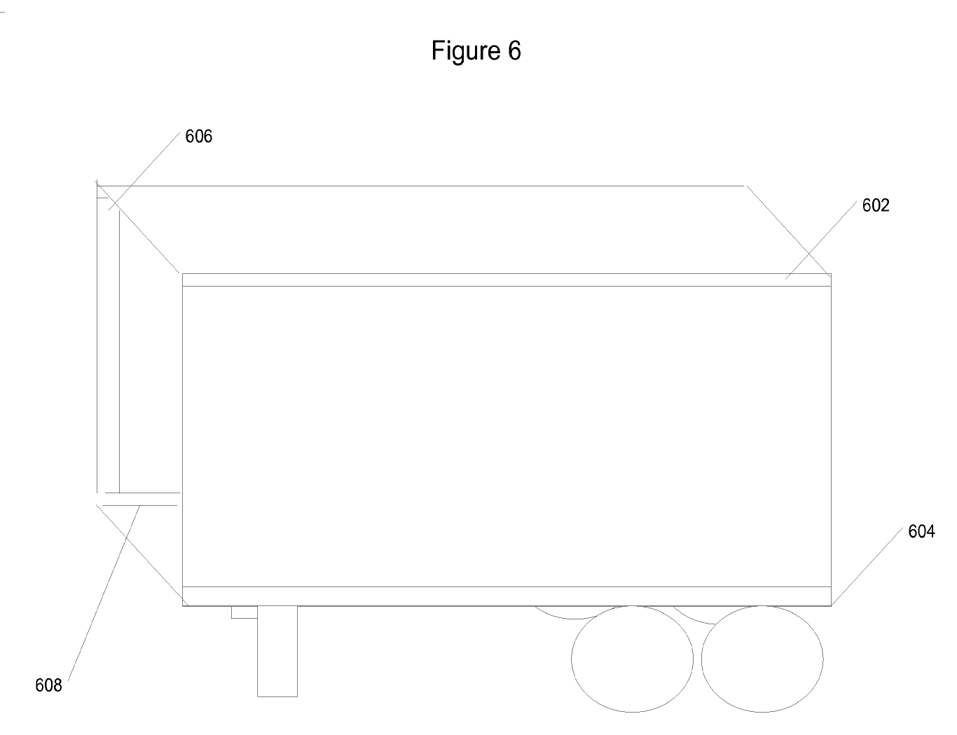

FIG. 6 illustrates the internal components of the mobile regulation and charging station 102. The battery modules 606 may be on rails 602 and 604. These rails may be able to transfer each module out in case of maintenance or replacement of battery module 606. As each module may hold above 1 MW, the station's control center 406 (FIG. 4) may route power away from each module in order for the station to remain at full operation although a module 606 may be removed.

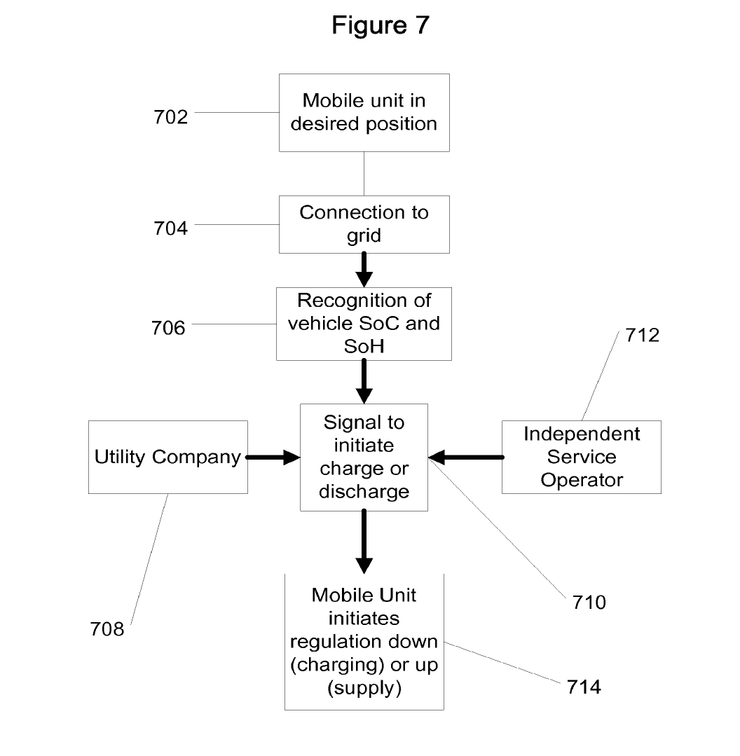

FIG. 7 is a flowchart showing the sequence of events and communication between the mobile unit and the governing utility company or Independent Service Operator (ISO). The mobile unit may be placed in a desired position along a low or medium voltage power line (step 702). Upon parking in the desired location, the connection mechanism 508 may connect to the power line (step 704). When connected, based upon the mobile station's battery bank's state of health, state of charge and current energy market condition (step 706), the govern utility company 708 or Independent Service Operator (ISO) 712 may initiate (step 710) either charging of mobile regulation and charging station's batteries or discharging back into the grid (step 714). The station may communicate with the utility company or ISO through station's controls center. In cases where the station is used for backup power or used for storage for renewable sources such as wind, the charge or discharge sequence may be set from the mobile regulation and charging station's control center 406 (FIG. 4).

The above description is illustrative and not restrictive. Many variations of the embodiments of the invention will become apparent to those skilled in the art upon review of this disclosure. The scope of the invention should, therefore, be determined not with the reference to the above description, but instead should be determined with reference to the pending claims along with their full scope or equivalents.

The functions described in this application may be implemented as software code to be executed by one or more processors using any suitable computer language such as, for example, Java, C++ or Perl using, for example, conventional or object-oriented techniques. The software code may be stored as a series of instructions, or commands on a computer read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Some embodiments of the present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings herein, a person of ordinary skill in the art will appreciate other ways and/or methods to implement the present invention.

In embodiments, some of the entities described herein may be embodied by a computer that performs any or all of the functions and steps disclosed.

Any recitation of “a”, “an” or “the” is intended to mean “one or more” unless specifically indicated to the contrary.

What is claimed is:

1. An apparatus comprising:
a connection unit configured to connect to a power line;
a control arm coupled to the connection unit and capable of raising the connection unit for connection to the power line;
a housing unit capable of storing one or more battery modules; and
a control center configured to communicate with one or more entities,
wherein the control center is further configured to initiate flow of electricity through the connection unit.

2. The apparatus of claim 1, wherein the one or more entities include a power utility company

3. The apparatus of claim 1, further comprising one or more outlets coupled to the housing and configured to provide electricity from the battery modules.

4. The apparatus of claim 1, wherein the control center is further configured to direct electricity from the connection unit to the one or more battery modules and charge the one or more battery modules via the electricity from the power line.

5. The apparatus of claim 1, wherein the control center is further configured to direct electricity from the one or more battery modules to the power line.

6. A method comprising:
placing a mobile regulation and charging station in proximity of a power line;
connecting a connection unit to the power line by rising a control arm of the mobile regulation and charging coupled to the connection unit; and
directing the flow of electricity to and from the power line using a control center coupled to the mobile regulation and charging station.

7. A method comparing:
communicating with a control center of a mobile regulation and charging station;
sending a command to the control center to connect a connection unit to a power line by rising a control arm coupled to the connection unit; and
sending a command to the control center to initiate flow of electricity to and from the power line.

8. The method of claim 7; wherein the communication with the control center of a mobile regulation and charging station is performed by a program code stored on a computer readable storage medium and executed by a processor.
